(19) United States
(12) Patent Application Publication
(10) Pub. No.: US 2011/0204284 A1
(43) Pub. Date: Aug. 25, 2011

(54) CARBON ELECTRODE BATCH MATERIALS AND METHODS OF USING THE SAME

(76) Inventors: Renee Kelly Duncan, Corning, NY (US); James William Zimmermann, Corning, NY (US)

(21) Appl. No.: 12/712,661

(22) Filed: Feb. 25, 2010

(51) Int. Cl. H01M 4/96; C04B 35/00

(52) U.S. Cl. 252/182.1; 264/105

(57) ABSTRACT

The disclosure relates to carbon electrode batch materials and methods of using and products of the same. In particular, the disclosure relates to batch materials for forming carbon electrodes comprising at least one activated carbon, at least one binder, and a carrier substantially comprising water. The disclosure further relates to methods comprising extruding said batch materials.

### FIELD OF THE DISCLOSURE

The disclosure relates to carbon electrode batch materials and methods of using the same. In particular, the disclosure relates to batch materials for forming carbon electrodes comprising at least one activated carbon, at least one binder, and a carrier substantially comprising water. The disclosure further relates to methods of making carbon electrode materials comprising extruding said batch materials.

### BACKGROUND

Carbon electrodes may be used, for example, in ultracapacitors, also known as supercapacitors, which are electrochemical devices that have highly reversible charge-storage processes per unit volume and unit weight as compared to batteries. Ultracapacitors may also be desirable because they may not contain hazardous or toxic materials and, therefore, may be easy to dispose of. Additionally, they may be utilized in large temperature ranges, and they have demonstrated cycle lives in excess of 500,000 cycles. Ultracapcitors may be used in a broad spectrum of electronic equipment such as, for example, batteries, fail-safe positioning in case of power failures, and electric vehicles.

The materials for making carbon electrodes may be environmentally unfriendly and costly. Likewise, the processes for making carbon electrodes may be complex, costly and time consuming. For example, some materials may require dispersing, comminution or purification prior to use in the batch material, and the processes may require high-pressure compaction of the batch material or drying at high temperatures and/or for long periods of time.

Thus, there exists a need for carbon electrode batch materials and related products that are less costly, environmentally friendly, and require less processing while still capable of producing reliable, homogeneous electrodes. Moreover, there is a need for methods to make carbon electrodes having these desirable properties.

### SUMMARY

In accordance with the detailed description and various exemplary embodiments described herein, the disclosure relates to novel carbon electrode batch materials and methods of using the same.

In various exemplary embodiments, the carbon electrode batch materials for forming carbon electrodes comprise at least one activated carbon, at least one binder, and a carrier substantially comprising water; wherein the at least one binder is substantially unfibrillated polytetrafluoroethylene (PTFE).

In other exemplary embodiments, the disclosure also relates to methods comprising extruding said batch materials. In at least one embodiment, the methods relate to extruding said batch materials using twin screw extruders.

The batch materials and methods of the disclosure may, in at least some exemplary embodiments, be environmentally friendly and/or cost effective.

### BRIEF DESCRIPTION OF THE DRAWINGS

The accompanying drawings are included to provide a further understanding of the invention, and are incorporated in and constitute a part of this specification. The drawings are not intended to be restrictive of the invention as claimed, but rather are provided to illustrate exemplary embodiments of the invention and, together with the description, serve to explain the principles of the invention.

FIG. 1 is a schematic representation of a method of making carbon electrode materials according to at least one embodiment of the disclosure;

FIGS. 2A and 2B are SEM micrographs of a carbon electrode material made according to one exemplary embodiment of the disclosure; and

FIG. 3 is a schematic representation of a twin screw extruder for use in making carbon electrode materials according to at least one embodiment of the disclosure.

### DETAILED DESCRIPTION

It is to be understood that both the foregoing general description and the following detailed description are exemplary and explanatory only and are not restrictive of the invention as claimed. Other embodiments will be apparent to those skilled in the art from consideration of the specification and practice of the embodiments disclosed herein. It is intended that the specification and examples be considered as exemplary only, with the true scope and spirit of the invention being indicated by the claims.

The disclosure relates to carbon electrode batch material and methods of using the same. As used herein, the terms “carbon electrode batch material,” “batch material,” and variations thereof, are intended to mean a formulation for use in making a carbon electrode material which can be used for making carbon electrodes. The carbon electrode batch material may comprise both solid and liquid components. In various embodiments, the carbon electrode batch material of the disclosure comprises at least one activated carbon, at least one binder material, and a carrier.

As used herein, the term “activated carbon,” and variations thereof, is intended to include carbon that has been processed to make it extremely porous and, thus, to have a high specific surface area. For example, activated carbon may be characterized by a high BET specific surface area ranging from 300 to 2500 m²/g. In various embodiments, the at least one activated carbon may be a powder having an average particle diameter ranging from 1 μm to 10 μm, for example from 3 μm to 8 μm, such as 5 μm. Activated carbon for use in the batch material includes, but is not limited to, those marketed under the trade name Activated Carbon by Kuraray Chemical Company Ltd, of Osaka, Japan, Carbon Activated Corporation of Compton, Calif., and General Carbon Corporation of Paterson, N.J.

In various embodiments, the batch material may comprise at least 70 wt % of activated carbon, for example at least 80 wt %, such as 85 wt %. As used herein, reference to weight percent for solids is relative to total particle loading; thus, 70 wt % of activated carbon indicates 70 wt % of solid particles or components in the batch are comprised of activated carbon.

As used herein, the term “binder material” and variations thereof, is intended to include materials that form a support, such as a fibrous lattice, for the other batch material components. In various embodiments, the binder material may be chemically inert and electrochemically stable.

In various embodiments, the at least one binder material present in the batch material may be substantially unfibrillated PTFE. As used herein with regard to PTFE, “substantially unfibrillated” is intended to mean that the PTFE particles have not been worked prior to or during preparation of the batch material to develop the fibrous nature of the material, for example by mixing with high shear forces, i.e., they are not yet fibrous.

In various embodiments, the at least one binder material may be a substantially unfibrillated PTFE having molecular weight ranging from 1×10⁶ g/mol to 10×10⁶ g/mol, for example from 2×10⁶ g/mol to 6×10⁶ g/mol, such as 5×10⁶ g/mol.

Substantially unfibrillated PTFE for use in the batch material includes, but is not limited to, those products marketed under the trade name Polytetrafluoroethylene by Sigma-Aldrich Corp. of St. Louis, Mo. and by Alfa Aesar, a division of Johnson Matthey, of Ward Hill, Mass.

In various embodiments, the batch material may comprise from 0.1 wt % to 20 wt % of at least one binder material, for example from 1 wt % to 10 wt %, such as 8 wt % of at least one binder material.

As used herein, the term “carrier,” and variations thereof, is intended to mean a material that aids the transport or flow of the batch material. In various embodiments of the disclosure, the carrier substantially comprises water, and in a further embodiment, the water may be deionized. As used herein, “substantially comprises water” is intended to mean that at least 50% by weight of the carrier comprises water, for example, at least 60 wt %, 70 wt %, 80 wt %, 90 wt %, 95 wt %, 99 wt % or 99.9 wt %.

In various embodiments, the carrier may comprise less than 200 wt % of the batch material as a super addition, for example less than 180 wt %, such as 160 wt %. As used herein, reference to weight percent for liquids is as a super addition, i.e., relative to 100 wt % of the solids. For example 200 wt % of the carrier indicates that for 100 g of batch solids, 200 g of carrier was present. In at least one embodiment, the amount of carrier present in the batch material is chosen such that the batch material is a moist malleable material, for example clay-like, prior to introduction to an extruder, and may exit the extruder in a semi-dry state.

In at least some embodiments, although the apparent wetness of the material may change during extrusion, the water content may remain substantially the same. Instead, in certain embodiments, the distribution of the carrier, such as water, within the material may change during extrusion, leading to a change in the apparent wetness of the material.

In various embodiments disclosed herein, the carbon electrode batch material may comprise at least 80 wt % activated carbon, unfibrillated PTFE, and a carrier substantially comprising water.

Additionally, the carbon electrode batch material may further comprise at least one carbon black. As used herein, the term “carbon black” is intended to include forms of amorphous carbon with a high specific surface area. For example, carbon black may be characterized by a high BET specific surface area, for example ranging from 25 m²/g to 2000 m²/g, such as ranging from 200 m²/g to 1800 m²/g and ranging from 1400 m²/g to 1600 m²/g. In various embodiments, the at least one carbon black may be a powder having an average particle diameter ranging from 1 μm to 40 μm, for example from 10 μm to 25 μm, such as 17 μm. Carbon blacks for use in the batch material include, but are not limited to, those marketed under the trade name BLACK PEARLS® 2000 by Cabot Corporation of Boston, Mass., VULCAN® XC 72 by Cabot Corporation of Boston, Mass., and PRINTEX® L6 by Evonik of Essen, Germany.

In various embodiments, the batch material may comprise an amount of carbon black ranging from 0.1 wt % to 15 wt %, for example 1 wt % to 10 wt %, such as 5 wt %.

Additionally, the carbon electrode batch material may further comprise at least one second binder material. In at least one embodiment, the at least one second binder material may be chosen from styrene-butadiene rubber copolymers, such as those marketed under the commercial name LICO® LHB-108P as a water-based dispersion by Lico Technology Corporation of Taiwan.

In various embodiments, the batch material may comprise an amount of at least one second binder material ranging from 0.1 wt % to 5 wt %, for example 1 wt % to 3 wt %, such as 1.5 wt %.

Additionally, the carbon electrode batch material may further comprise at least one additive. As used herein, the term “additive” includes, but is not limited to, moisture absorbers.

In at least one embodiment of the batch material, the at least one additive is a moisture absorber. In a further embodiment, the moisture absorber may be chosen from carboxymethylcelluloses, such as, for example those marketed under the trade name Carboxylmethylcellulose (CMC) by Sigma-Aldrich Corp. of St. Louis, Mo. and EAGLE® CMC by Anqiu Eagle Cellulose Company of China.

In various embodiments, the batch material may comprise an amount of at least one additive ranging from 0.01 wt % to 5 wt %, for example 0.1 wt % to 2 wt %, such as 0.5 wt %.

In at least one embodiment of the disclosure, the solid batch components are chosen to be compatible with water as a carrier. In a further embodiment of the disclosure, the carbon electrode batch materials are chosen to be compatible with acetonitrile for use as an electrolyte.

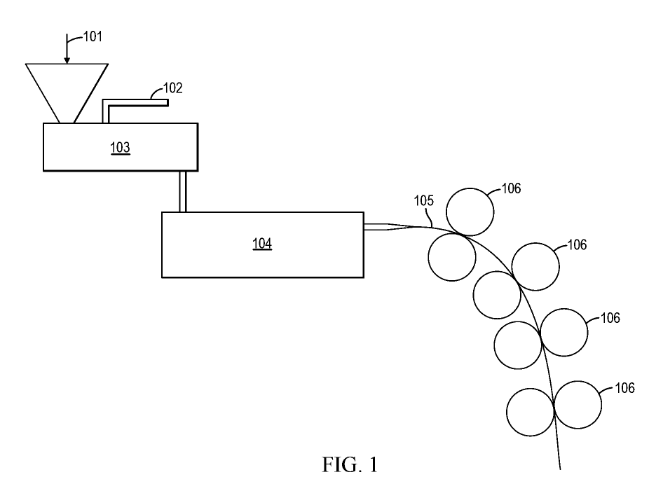

The disclosure further relates to methods of making carbon electrode material comprising extruding said carbon electrode batch materials. In various embodiments, the methods of making carbon electrode material comprise mixing a carbon electrode batch material as described herein; extruding the batch material using a twin screw extruder to make extruded material; and calendaring the extruded material to make calendared material. FIG. 1 is a schematic representation of a method of making carbon electrode material according to one exemplary embodiment of the disclosure.

As disclosed herein and exemplified in FIG. 1, mixing carbon electrode batch material comprises combining the solid batch components 101, including the at least one carbon and at least one binder, with the liquid components 102, including the carrier, in a mixer 103. The mixing may be manual or mechanical, for example using TILT-A-MIX® mixing equipment marketed by Processall Inc., of Cincinnati, Ohio.

In various embodiments, the batch components may be used in their as-received state, meaning that they are not further treated, such as by solution mixing, sonication, heating, or in-situ polymerization, before mixing with the other batch components.

In additional embodiments, the carbon electrode batch material is substantially free of fibrillation before extrusion. As used herein with regard to the batch material, the term “substantially free of fibrillation,” and variations thereof, is intended to mean that the batch material has not been worked prior to extrusion to develop the fibrous nature of the at least one binder material, for example by mixing with high shear forces.

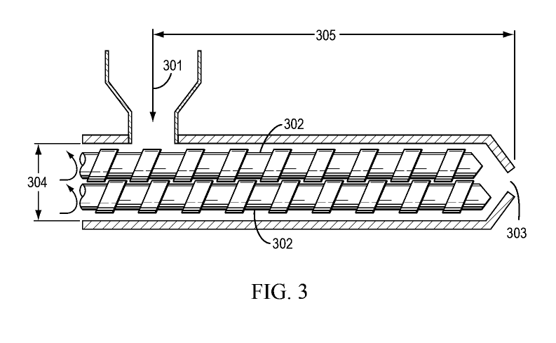

As exemplified in FIG. 1, the carbon electrode batch material may be fed into a twin screw extruder 104. As exemplified in FIG. 3, the twin screw extruder may comprise two screws 302, with an input 301 and exit through a die 303. In various embodiments, the twin screw extruder may have an extrusion chamber aspect ratio (length 305/diameter 304) ranging from 30:1 to 7:1, for example ranging from 20:1 to 10:1, such as 15:1. In at least one embodiment, the extruder may be an 18 mm twin screw extruder.

The twin screw extruder may be arranged in various configurations, including, but not limited to consolidation, kneading, mixing, and blistering stages. Devolitization and deairing may also be implemented using vacuum. In at least one embodiment, the configuration may comprise mixing, then kneading, and then mixing.

It is within the ability of one skilled in the art to select an appropriate die for the extruder exit, including for example, consideration of the desired thickness of the extruded material and the ability of the extruded material to flow through the die without additional pressure. In at least one embodiment, the die may be a slot die.

In various embodiments, the extrusion may be performed at a continuous rate under the constant conditions of input rate and screw speed. For example, the batch mixture may be manually or automatically fed into the extruder and extruded at a constant screw speed. In various embodiments the screw speed may be selected from the range of 10 rpm to 500 rpm, for example from the range of 10 rpm to 100 rpm, such as a constant screw speed of 50 rpm.

In various embodiments, the extrusion may be performed at batch material temperatures ranging from 0° C. to 100° C., for example below 50° C., such as approximately room temperature, approximately 27° C.

In at least one embodiment, the batch material may enter the twin screw extruder as a moist (but not fluid) malleable material and may exit the extruder in a semi-dry state.

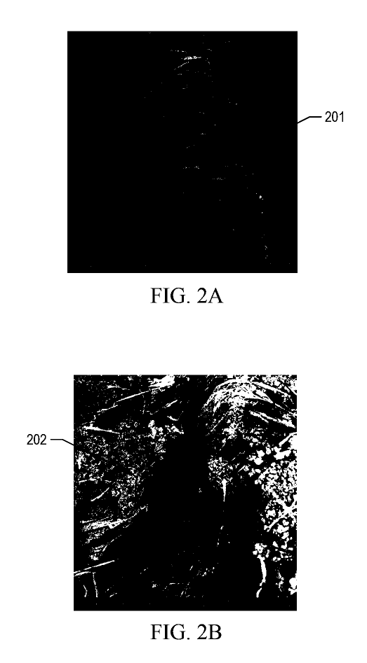

In at least one embodiment of the disclosure, the at least one binder of the batch material is not plasticized by the shear stresses exerted by the screws of the twin screw extruder. Further, in at least one embodiment, as depicted for example in the scanning electron microscopy images of FIGS. 2A and 2B, taken at a magnification of 355× and 725× respectively, the extrusion of the at least one binder does not result in a large number of fibrillized binder particles coalescing and forming substantial agglomeration. Rather, the binder has fibrillized without coalescing, as seen at 201 and 202, thereby resulting in a substantially uniform distribution of the components in the extruded material.

Upon exiting the extruder through a die, the extruded material may be calendared. For example, FIG. 1 depicts the extruded material 105 exiting the extruder 104 and being calendared by four rollers 106. It is within the ability of one skilled in the art to select the calendaring conditions, including the number of passes through the rollers and their thickness settings, based on, for example, the desired thickness and flexibility of the calendared material.

In various embodiments, the calendared material may be calendared to a thickness of less than 0.01 inches, for example less than 0.005 inches or 0.002 inches, such as 0.0014 inches or 0.0012 inches.

In additional embodiments, the calendared material may be dried, for example by heating, vacuum, dry air flow, and combinations thereof. In at least one embodiment, the calendared material may be vacuum dried. It is within the ability of one skilled in the art to determine the appropriate apparatus and drying time and temperature for drying the calendared material. For example, in at least one embodiment, the material may be dried at a temperature ranging from 80° C. to 130° C., such a ranging from 100° C. to 120° C., or at 110° C.

In at least one embodiment, the carbon electrode material produced after drying is flexible. For example, a carbon electrode made from the carbon electrode material may be rollable into a coil.

In an additional embodiment, the carbon electrode material may be compatible with conventional electrolytes, such as acetonitrile electrolyte.

In at least one embodiment of the disclosure, the methods of making carbon electrode material may be less complex, costly, and/or time consuming relative to conventional methods of making carbon electrode materials. For example, batch components may be readily available in the market and/or may not require mixing, crushing, or dispersing, and the mixing and extruding may not require added pressure. Additionally, the methods of making carbon electrode material disclosed herein may be more environmentally friendly than conventional methods. For example, the disclosed methods may use water as a carrier and not organic solvents.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the batch material” or “batch material” is intended to mean at least one batch material.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLE

The following example is not intended to be limiting of the invention as claimed.

### Example 1

100 g of batch material was prepared by manually mixing 85 wt % of activated carbon having a particle size of approximately 5 μm, 5 wt % of carbon black having an average particle size of 17 μm, 8 wt % of PTFE having a molecular weight of 5×106 g/mol, 1.5 wt % of styrene-butadiene rubber in a water-based dispersion, and 0.5 wt % of carboxymethylcellulose. 160 wt % deionized water was added and the batch material was manually mixed.

The moist batch material was manually fed into an 18 mm co-rotating self swiping twin screw extruder with an extrusion chamber aspect ratio (length/diameter) of 15:1. The material was passed through the extruder once at a constant screw speed of 50 rpm. No pressure or heat was used. The material was extruded through a slot die (oval shaped) of length 0.75 inches and radius 0.25 inches. The extruded material was calendared for 4 passes at different spacings to form a thin and rectangular shape. The calendared material was then dried at 110° C. for 24 hours under vacuum.

The dried carbon electrode materials were characterized for thickness and fibrillization and/or agglomeration of the PTFE using Scanning Electron Microscopy (SEM). The dried carbon electrode material was approximately 0.0014 inches thick. Additionally, as seen for example in FIGS. 2A and 2B, the materials contained fibrillized PTFE that did not agglomerate and instead formed a substantially uniform carbon electrode material.

The dried samples were also placed in acetonitrile electrolyte at room temperature for 24 hours to determine compatibility. Upon removal from ACN, the electrode did not disintegrate, thereby confirming its compatibility with the electrolyte.

1. Carbon electrode batch material comprising at least one activated carbon, at least one binder material, and a carrier substantially comprising water;
wherein the at least one binder is substantially unfibrillated polytetrafluoroethylene.

2. The carbon electrode batch material of claim 1, wherein the at least one activated carbon is a powder having an average particle diameter ranging from 1 micron to 10 microns.

3. The carbon electrode batch material of claim 1, wherein the at least one activated carbon comprises at least 80 wt % of the batch material.

4. The carbon electrode batch material of claim 1, wherein the carrier comprises less than 200 wt % of the batch material as a super addition.

5. The carbon electrode batch material of claim 1, further comprising at least one second binder material.

6. The carbon electrode batch material of claim 1, further comprising at least one second binder material chosen from styrene-butadiene rubber copolymers.

7. The carbon electrode batch material of claim 1, further comprising at least one additive.

8. The carbon electrode batch material of claim 1, further comprising at least one additive chosen from carboxymethylcelluloses.

9. The carbon electrode batch material of claim 1, further comprising at least one carbon black.

10. A method of making a carbon electrode material comprising:
mixing a carbon electrode batch material comprising at least one activated carbon, at least one binder material, and a carrier substantially comprising water;
extruding the batch material through a twin screw extruder to make extruded material; and
calendaring the extruded material to make calendared material;
wherein the at least one binder is substantially unfibrillated polytetrafluoroethylene.

11. The method of claim 10, wherein the at least one activated carbon comprises at least 80 wt % of the batch material.

12. The method of claim 10, wherein at least the mixing, extruding, and calendaring are performed at approximately room temperature.

13. The method of claim 10, wherein the twin screw extruder has an extrusion chamber aspect ratio ranging from 30:1 to 7:1.

14. The method of claim 10, wherein the calendaring is repeated until the calendared material is less than 0.01 inches thick.

15. The method of claim 10, further comprising drying the calendared material.

16. The method of claim 10, further comprising drying the calendared material using a vacuum dryer.

17. The method of claim 10, wherein the extruding and calendaring is substantially continuous.

18. The method of claim 10, wherein the extruder operates at a substantially continuous rate.

19. The method of claim 10, wherein the carrier comprises less than 200 wt % of the batch material as a super addition.

20. The method of claim 10, wherein the batch material further comprises at least one second binder material.

21. The method of claim 10, wherein the batch material further comprises at least one second binder material chosen from styrene-butadiene rubber copolymers.

22. The method of claim 10, wherein the batch material further comprises at least one additive.

23. The method of claim 10, wherein the batch material further comprises at least one additive chosen from carboxymethylcelluloses.

24. The method of claim 10, wherein the batch material further comprises at least one carbon black.

25. Carbon electrode batch material comprising at least one activated carbon, at least one binder material, and a carrier substantially comprising water;
wherein the at least one binder is substantially unfibrillated polytetrafluoroethylene and the batch material is substantially free of fibrillation.

26. A method of making a carbon electrode material comprising:
mixing a carbon electrode batch material comprising at least one activated carbon, at least one binder material, and a carrier substantially comprising water;
extruding the batch material through a twin screw extruder to make extruded material; and
calendaring the extruded material to make calendared material;
wherein the at least one binder is substantially unfibrillated polytetrafluoroethylene and the batch material is substantially free of fibrillation before the extruding.
